(19) United States
(12) Patent Application Publication
(10) Pub. No.: US 2023/0258574 A1
(43) Pub. Date: Aug. 17, 2023

(54) METHOD FOR DETECTING DEFECTS IN A COMPONENT, METHOD FOR TRAINING A MACHINE LEARNING SYSTEM, COMPUTER PROGRAM PRODUCT, COMPUTER-READABLE MEDIUM, AND SYSTEM FOR DETECTING DEFECTS IN A COMPONENT

(71) Applicant: MTU Aero Engines AG, München (DE)

(72) Inventors: Marius BONHAGE, Muenchen (DE); Lars ASCHERMANN, Muenchen (DE); Frank SEIDEL, Muenchen (DE); Uwe SCHULZE, Muenchen (DE); Matthias LÜTKE, Muenchen (DE); Philipp DÖBBER, Muenchen (DE)

(21) Appl. No.: 17/619,135

(22) PCT Filed: Jun. 24, 2020
(86) PCT No.: PCT/DE2020/000141

§ 371 Date: Aug. 26, 2022

(30) Foreign Application Priority Data
Jun. 27, 2019 (DE) 10 2019 209 408.2

(51) Int. Cl. G01N 21/91; G06T 7/00

(52) U.S. Cl. CPC G01N 21/91; G06T 7/0004; G01N 2021/8883

(57) ABSTRACT

Provided is a method for detecting defects, in particular cracks and/or pores, in a component, in particular in a component of a turbomachine, preferably in a component of an engine, the method including the following steps: applying penetrant to at least a sub-region of the component such that the penetrant penetrates into any defects, in particular cracks and/or pores, present in the component; cleaning the surface of the component of penetrant that has not penetrated into defects, in particular cracks and/or pores, of the component; capturing an image, in particular a complete image, of the component; inputting the captured image into a machine learning system trained to detect defects, in particular cracks and/or pores; and detecting defects, in particular cracks and/or pores, in the component by machine learning system on the basis of light emitted and/or reflected by the penetrant in the defects, in particular cracks and/or pores.

The invention relates to a method for detecting defects in a component, a method for training a machine learning system, a computer program product, a computer-readable medium, and a system for detecting defects in a component.

### BACKGROUND

It is known to perform penetrant testing on components, such as components of an engine, to detect defects, in particular cracks and/or pores, in components. In such tests, the surface of the component is cleaned, whereupon a penetrant is applied to the surface. Then, a dwell time during which the penetrant seeps into the defects, in particular cracks and/or pores, of the component is waited to elapse. Subsequently, the penetrant is removed from the surface so that the penetrant remains only in the defects, in particular cracks and/or pores. The penetrant can then be optically detected in an image of the component.

### SUMMARY OF THE INVENTION

Previously known methods for detecting defects, in particular cracks and/or pores, have the disadvantage that personnel trained in a complex manner or over a long period of time and/or intensively trained and experienced persons are needed to detect the defects, in particular cracks and/or pores. When defect detection is performed by humans, a large amount of time is needed for each component in order to inspect the respective component for defects, in particular cracks and/or pores. Moreover, staff turnovers cause loss of knowledge and experience. In addition, in previously known methods, the light reflected and/or emitted by the penetrant must include or be light that is visible to humans. This significantly limits the choice of the penetrant.

It is an object of the invention to provide a method and system that allows defects, in particular cracks and/or pores, in components to be detected in a technically simple and rapid manner using a penetrant.

The present invention provides a method for detecting defects, in particular cracks and/or pores, in a component, in particular in a component of a turbomachine, preferably in a component of an engine, the method including the following steps: applying penetrant to at least a sub-region of the component such that the penetrant penetrates into any defects, in particular cracks and/or pores, present in the component; cleaning the surface of the component of penetrant that has not penetrated into defects, in particular cracks and/or pores, of the component; capturing an image, in particular a complete image, of the component; inputting the captured image into a machine learning system trained to detect defects, in particular cracks and/or pores; and detecting defects, in particular cracks and/or pores, in the component by means of the machine learning system on the basis of light emitted and/or reflected by the penetrant in the defects, in particular cracks and/or pores.

An advantage of this is that the component can be inspected for defects, in particular cracks and/or pores, in an automated and technically simple manner. Moreover, no specially trained person is needed to the detect the defects, in particular cracks and/or pores. This reduces the costs of the method. In addition, it is possible to use a penetrant that reflects and/or emits light in a range that is invisible to humans. This makes it possible to even further improve the detection of defects, in particular cracks and/or pores.

The present invention also provides a method for training a machine learning system to detect defects, in particular cracks and/or pores, in a component, in particular in a component of a turbomachine, preferably in a component of an engine, the method including the following steps: providing a machine learning system including, in particular, a neural network; inputting an image, in particular a complete image, of the component into the machine learning system, the image including light emitted and/or reflected by penetrant present in defects, in particular cracks and/or pores, of the component; detecting defects, in particular cracks and/or pores, in the component by means of the machine learning system on the basis of light emitted and/or reflected by the penetrant in the defects, in particular cracks and/or pores; outputting, by the machine learning system, information as to whether or not the component has defects, in particular cracks and/or pores; and inputting correct information as to whether or not the component has defects, in particular cracks and/or pores, into the machine learning system in order to train the machine learning system.

An advantage of this is that the machine learning system can be trained in a technically simple, rapid and reliable manner to detect defects, in particular cracks and/or pores, in the component.

The present invention also provides a computer program product including instructions which are readable by a processor of a computer and which, when executed by the processor, cause the processor to execute one of the above-described methods. The present invention also provides a computer-readable medium on which this computer program product is stored.

The present invention also provides a system for detecting defects, in particular cracks and/or pores, in a component, in particular in a component of a turbomachine, preferably in a component of an engine, the system including the following: an image-capture device for capturing an image, in particular a complete image, of the component, the image including light emitted and/or reflected by penetrant present in defects, in particular cracks and/or pores, of the component; and a trained machine learning system for detecting defects, in particular cracks and/or pores, in the component on the basis of the light emitted and/or reflected by the penetrant in the defects, in particular cracks and/or pores, of the component.

This is advantageous in that the system can inspect the component for defects, in particular cracks and/or pores, in an automated, technically simple and rapid manner. Moreover, no specially trained personnel is needed to the detect the defects, in particular cracks and/or pores. In addition, the penetrant may reflect and/or emit light in the range that is invisible to humans. This makes it possible to increase the reliability of the detection of defects, in particular cracks and/or pores.

In accordance with an embodiment of the method for detecting defects, in particular cracks and/or pores, the penetrant emits and/or reflects light that is visible to humans.

This is advantageous in that the result of the method and the reliability of the method can be verified by humans in a technically simple and rapid manner. This increases confidence in the method.

In accordance with an embodiment of the method for detecting defects, in particular cracks and/or pores, the method further includes the following step: outputting, by the machine learning system, an image of the component, the defects, in particular cracks and/or pores, detected by the machine learning system being marked in the image.

An advantage of this is that further actions can be performed in an automated manner on the basis of the outputted information. For example, the components that have been determined to have defects, in particular cracks and/or pores, may be inspected in greater detail, and/or the defects, in particular the cracks and/or pores, may be repaired in an automated manner.

In accordance with an embodiment of the method for detecting defects, in particular cracks and/or pores, the machine learning system includes a neural network; in particular, the machine learning system is a neural network.

This is advantageous in that the method is particularly reliable and fast.

In accordance with an embodiment of the method for training the machine learning system, the correct information is created on the basis of defects, in particular cracks and/or pores, detected by a human in the complete image.

This is advantageous in that the system can be trained in a technically simple manner. In particular, it can be achieved or ensured in a technically simple manner that the machine learning system detects defects, in particular cracks and/or pores, particularly reliably.

In accordance with an embodiment of the system, the penetrant emits and/or reflects light that is visible to humans.

This is advantageous in that the result outputted by the system can be quickly verified by a human in a technically simple manner. Thus, the reliability of the system can be easily verified by a human, whereby confidence in the system can be particularly easily increased.

### BRIEF DESCRIPTION OF THE DRAWINGS

The invention will now be described in more detail with reference to a drawing of an exemplary embodiment.

In the drawing,

FIG. 1 is a schematic view of an embodiment of an inventive system for detecting defects, in particular cracks and/or pores, in a component.

### DETAILED DESCRIPTION

In the following description, the same reference numerals are used for identical or functionally equivalent elements.

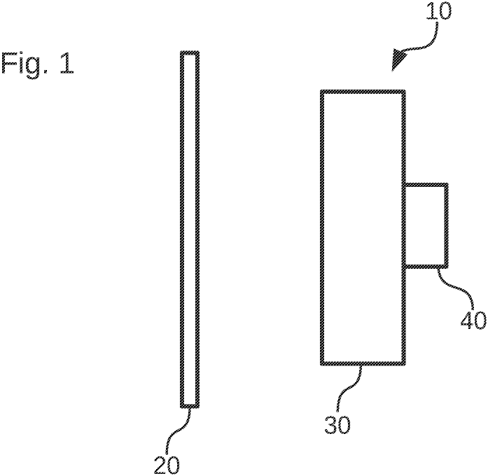

FIG. 1 shows a schematic view of an embodiment of an inventive system 10 for detecting defects, in particular cracks and/or pores, in a component 20, in particular in a component 20 of a turbomachine, preferably in a component 20 of an engine. The system 10 for detecting defects, in particular cracks and/or pores, in a surface of a component 20; e.g., in blades of a rotor of the engine, includes an image-capture device 30 and a machine learning system 40.

Image-capture device 30 (e.g., a digital camera) captures an optical image, in particular a complete image, of component 20. “Complete image” means in particular that no image of a sub-region of the component 20 is generated, but rather that an optical image is generated of the entire or complete component 20 (from one perspective).

Machine learning system 40 is configured and trained to detect defects, in particular cracks and/or pores, in component 20.

A penetrant inspection (dye penetrant inspection; DP) is performed on component 20, for example in accordance with DIN EN ISO 3452-1:2014-09. The penetrant inspection is capable of detecting defects, in particular cracks and/or pores, in the surface of component 20.

Initially, the surface of at least a sub-region of the surface of component 20, in particular the entire surface of component 20, is cleaned. Subsequently, a penetrant is applied to the cleaned sub-region of the surface of component 20. After a dwell time, which may be dependent on the particular penetrant used, the penetrant is removed from the surface of component 20 in such that the penetrant remains only in defects, in particular cracks and depressions, of component 20.

Then, an image, in particular a complete image, is generated of component 20. In this process, natural light; i.e., light of the spectrum that is visible to humans, and/or ultraviolet light and/or infrared light may be radiated or fall on component 20 or the sub-region of component 20. The light emitted and/or reflected by the penetrant remaining in the cracks and/or pores and the light emitted and/or reflected by the surface of component 20 are used to generate the image. This image of component 20 is input into machine learning system 40. The complete image may be composed of a plurality of individual images of component 20.

The penetrant may include or be a dye penetrant and/or a fluorescent penetrant. During the dwell time, the penetrant seeps into any defects, in particular cracks and/or pores, that may be present. The light that excites the penetrant to emission or is (partially) reflected by the penetrant may include or be visible light, UV light and/or infrared light. The penetrant may emit and/or reflect light that is visible to humans. However, it is also possible that the dye penetrant may emit and/or reflect light that is invisible to humans, such as light in the infrared range and/or light in the ultraviolet range. Other combinations of visible and invisible light are also possible.

Machine learning system 40 is trained to detect or identify defects, in particular cracks and/or pores, in component 20 or in the surface of component 20 on the basis of the penetrant that is located in the defects, in particular cracks and/or pores, when the complete image is captured. The penetrant ensures that, due to the penetrant present in the defects, in particular cracks and/or pores, the defects, in particular cracks and/or pores, will appear in a different color or color shade and/or with a different brightness than the remainder of the surface of component 20.

Machine learning system 40 usually runs on a computer or processor.

Machine learning system 40 may include a support vector machine (SVM), a neural network, a deep neural network (DNN), a convolutional neural network (CNN), and the like.

Machine learning system 40 outputs at least one piece of information, namely whether or not the complete image of component 20, or component 20, shows or has at least one defect or at least one crack or at least one pore. If machine learning system 40 has not detected a defect; i.e., a crack or pore, in the complete image, component 20 may be marked as defect-free. Then, the next component 20 may be inspected.

If machine learning system 40 detects at least one defect; i.e., at least one crack and/or at least one pore, in the surface, component 20 may be marked as defective. A user of the system 10 may then be made aware of this. It is conceivable that the user may manually inspect component 20 for defects, in particular cracks and/or pores, for example in the locations or areas indicated by system 10. It is also conceivable that the detected defects, in particular cracks and/or pores, may be repaired in an automated manner. This may be followed, for example, by performing a new penetrant inspection.

In addition, machine learning system 40 may output or generate an image in which the detected or identified defects, in particular cracks and/or pores, in the surface of component 20 are marked. These markings may include, for example, colored elements corresponding to the shape of the defect, of the crack, or of the pore, and labels or the like.

In particular, it is possible that a single complete image of component 20 (and not a plurality of individual images of sub-regions of component 20) is input into machine learning system 40 to inspect the respective component 20 for defects, in particular cracks and/or pores. Usually, there is no repeated image capturing of the same component 20 (from the same perspective and/or from similar perspectives). When a complete image is input into machine learning system 40, the machine learning system usually does not analyze or process sub-regions of component 20 successively; i.e., portion by portion or step by step. The defects, in particular cracks and/or pores, are detected by machine learning system 40 in the overall context of component 20.

Machine learning system 40 is trained to detect defects, in particular cracks and/or pores, by means of the penetrant as follows:

An image or a captured image or a complete image of a component is input into the machine learning system 40. The image or complete image shows a picture of component 20 where a penetrant has been applied to the surface subsequent to cleaning the surface and where, after a dwell time, the penetrant has been removed from the surface of component 20 such that the penetrant has remained only in defects, in particular cracks and/or pores, that may be present in component 20. During image capture, component 20 has been illuminated such that the surface where no defects, in particular cracks and/or pores, are present, and the penetrant appear in different colors and/or color shades and/or with different brightnesses.

Subsequently, machine learning system 40 outputs information as to whether or not component 20 has defects, in particular cracks or pores. In addition, machine learning system 40 may output an image in which the defects, in particular cracks and/or pores, are marked. A trainer; e.g., a human, corrects or correctly indicates whether or not the respective component 20 (in the perspective of the image or complete image) contains any defects, in particular cracks and/or pores. This is input into machine learning system 40 so that machine learning system 40 can learn.

In addition, the defects, in particular cracks and/or pores, detected or identified by machine learning system 40 may be compared by the trainer with the defects, in particular cracks and/or pores, he or she detects in the complete image; i.e., the image that was input into machine learning system 40. Any differences between these two images are input into machine learning system 40 so that machine learning system 40 learns which defects, in particular cracks and/or pores, have been detected correctly, which defects, in particular cracks and/or pores, have not been detected, and in which locations a defect; i.e., a crack and/or a pore, have/has been detected although no defect or crack or pore is present.

This training of machine learning system 40 may be repeated with a multiplicity of images, in particular complete images, if possible of different components 20.

It is also conceivable that images which have been correctly marked by a human as “showing” defects, in particular cracks and/or pores (also referred to as “including an indication”) or as “not showing” defects, in particular cracks and/or pores (also referred to as “not including an indication”) may be input into machine learning system 40 as “truth.” It is also conceivable that the image in which a human has correctly marked the locations or positions of the defects, in particular cracks and/or pores, may be input as “truth” into machine learning system 40, and that machine learning system 40 may autonomously identify, and thereby learn, from the differences between the generated image in which the defects, in particular cracks and/or pores, detected by machine learning system 40 are marked and the image in which the defects, in particular cracks and/or pores, correctly detected by a human are marked.

Machine learning system 40 may be trained by different persons. This means that different people identify defects, in particular cracks and/or pores, in the complete image and input this information into machine learning system 40.

Machine learning system 40 may in particular be trained until it detects defects, in particular cracks and/or pores, in component 20 at least as efficiently as a human (trained for this purpose).

Machine learning system 40 may classify the image, in particular the complete image, of component 20. The image or complete image may be classified, for example, into the category “component without defects” or “component without cracks or pores” or into the category “component with defect” or “component with cracks and/or pores.” It is also possible that the length of the defect or defects, in particular of the crack or cracks or of the pore or pores, the width of the defect or defects, in particular of the crack or cracks, the size or diameter of the defect or pore, and/or the number of defects, in particular cracks and/or pores, may be used as classification characteristics.

After machine learning system 40 has been trained, and during use of system 10, no person is needed to recognize the defects, in particular cracks and/or pores, by means of the penetrant. Rather, the person only has to monitor or control the operation of the system 10 including the machine learning system 40.

Component 20 may be, for example, a component of an engine. For example, component 20 may be a rotor or a blade of a high-pressure compressor (HPC) or a rotor or a blade of a high-pressure turbine (HPT) of an engine. The engine may in particular be an engine of an aircraft. The engine may be a jet engine.

The penetrant may in particular be a crack-detection agent.

It is possible that no database is used in detecting the defects, in particular cracks and/or pores. Typically, no interferometry is used to detect the defects, in particular cracks and/or pores. It is possible to use only one image-capture device for capturing an image or the complete image of a component.

List of Reference Numerals

| | |
|---|---|
| 10 | system |
| 20 | component |
| 30 | image-capture device |
| 40 | machine learning system |

What is claimed is:

1-10. (canceled)

11. A method for detecting defects in a component, the method comprising the following steps:
applying penetrant to at least a sub-region of the component such that the penetrant penetrates into any defects present in the component;
cleaning a surface of the component of penetrant that has not penetrated into defects of the component;
capturing an image of the component;
inputting the captured image into a machine learning system trained to detect defects; and detecting defects in the component via the machine learning system on the basis of light emitted or reflected by the penetrant in the defects.

12. The method as recited in claim 11 wherein the image is a complete image of the component.

13. The method as recited in claim 11 wherein the component is a turbomachine engine component.

14. The method as recited in claim 11 wherein the defect is a crack or a pore.

15. The method as recited in claim 11 wherein the penetrant emits or reflects light visible to humans.

16. The method as recited in claim 11 further comprising the following step: outputting, by the machine learning system, an image of the component, the defects detected by the machine learning system being marked in the image.

17. The method as recited in claim 11 wherein the machine learning system includes a neural network.

18. A method for training a machine learning system to detect defects, in particular cracks or pores, in a component, in particular in a component of a turbomachine, preferably in a component of an engine, the method comprising the following steps:
providing a machine learning system including, in particular, a neural network; inputting an image, in particular a complete image, of the component into the machine learning system, the image including light emitted or reflected by penetrant present in defects, in particular cracks and/or pores, of the component;
detecting defects, in particular cracks or pores, in the component via the machine learning system on the basis of light emitted or reflected by the penetrant in the defects, in particular cracks and/or pores;
outputting, by the machine learning system, information as to whether or not the component has defects, in particular cracks or pores; and
inputting correct information as to whether or not the component has defects, in particular cracks and/or pores, into the machine learning system in order to train the machine learning system.

19. The method as recited in claim 18 wherein the correct information is created on the basis of defects detected by a human in the complete image.

20. A computer program product comprising instructions which are readable by a processor of a computer and which, when executed by the processor, cause the processor to execute the method as recited in claim 11.

21. A computer-readable medium on which the computer program product as recited in claim 20 is stored.

22. A system for detecting defects, in particular cracks or pores, in a component, in particular in a component of a turbomachine, preferably in a component of an engine, the system comprising the following:
an image-capture device for capturing an image, in particular a complete image, of the component, the image including light emitted and/or reflected by penetrant present in the defects, in particular cracks and/or pores, of the component; and
a trained machine learning system for detecting defects, in particular cracks or pores, in the component on the basis of the light emitted and/or reflected by the penetrant in the defects, in particular cracks or pores, of the component.

23., The system as recited in claim 22, wherein the penetrant emits or reflects light that is visible to humans.
